(19) United States
(12) Patent Application Publication
(10) Pub. No.: US 2026/0010737 A1
(43) Pub. Date: Jan. 8, 2026

(54) INFORMATION PROCESSING APPARATUS, DETERMINATION METHOD, AND NON-TRANSITORY COMPUTER-READABLE STORAGE MEDIUM

(71) Applicant: NEC Corporation, Tokyo (JP)

(72) Inventors: Kazuya KAKIZAKI, Tokyo (JP); Yuto MATSUNAGA, Tokyo (JP); Ryo FURUKAWA, Tokyo (JP); Toshinori ARAKI, Tokyo (JP); Masaya FUJIWAKA, Tokyo (JP); Junichi FUNADA, Tokyo (JP); Jianquan LIU, Tokyo (JP)

(73) Assignee: NEC Corporation, Tokyo (JP)

(21) Appl. No.: 19/245,594

(22) Filed: Jun. 23, 2025

(30) Foreign Application Priority Data
Jul. 4, 2024 (JP) 2024-108428

(51) Int. Cl. G06F 40/40

(52) U.S. Cl. CPC G06F 40/40

(57) ABSTRACT

An information processing apparatus includes a truth/falsity determination unit for determining truth/falsity of a matter suggested in content, and a condition changing unit for changing a condition of truth/falsity determination, and the truth/falsity determination unit redetermines truth/falsity of the matter suggested in the content under a condition after the changing by the condition changing unit. According to the information processing apparatus, it is also possible to avoid making an incorrect decision based on content including incorrect matters.

### INCORPORATION BY REFERENCE

This application is based upon and claims the benefit of priority from Japanese patent application No. 2024-108428, filed on Jul. 4, 2024, the disclosure of which is incorporated herein in its entirety by reference.

### TECHNICAL FIELD

The present disclosure relates to an information processing apparatus, a determination method, and a determination program.

### BACKGROUND ART

Various kinds of content such as news articles are released every day. Such released content may include content which includes factually incorrect matters, such as fake news. Examples of a technology as a countermeasure against such content include a technology in Patent Literature 1. A news distribution system described in Patent Literature 1 requests predetermined experts to perform fact checking on news articles. Then, the news distribution system adds fairness scores of the news articles when positive evaluation is achieved as results of the fact checking. It is thus possible for users to determine whether the news articles are likely to be reliable with reference to the fairness scores.
Patent Literature 1: Japanese Unexamined Patent Publication No. 2024-15904

Since the fact checking by experts entails time, effort, and a cost, automation of the fact checking, in other words, truth/falsity determination on matters suggested in content has been desired. In a case where truth/falsity of the matters suggested in content is determined automatically, a technology for improving determination accuracy is also needed. However, J P 2024-15904 A, which does not even mention the automation of fact checking, does not describe such a technology as a matter of course.

The present disclosure has been made in view of the above problems, and an example object of the present disclosure is to provide a technology capable of improving accuracy of truth/falsity determination on matters suggested in content.

### SUMMARY

An information processing apparatus according to an example aspect of the present disclosure includes truth/falsity determination means for determining truth/falsity of a matter suggested in content, and condition changing means for changing a condition of truth/falsity determination, and the truth/falsity determination means redetermines truth/falsity of the matter suggested in the content under a condition after the changing by the condition changing means.

A determination method according to an example aspect of the present disclosure includes executing, at least by one processor, truth/falsity determination processing of determining truth/falsity of a matter suggested in content, condition changing processing of changing a condition of truth/falsity determination, and processing of redetermining truth/falsity of the matter suggested in the content under the condition after the changing.

A determination program according to an example aspect of the present disclosure is a determination program that causes a computer to function as truth/falsity determination means for determining truth/falsity of a matter suggested in content and condition changing means for changing a condition of truth/falsity determination, and the truth/falsity determination means redetermines truth/falsity of the matter suggested in the content under the condition after the changing by the condition changing means.

According to an illustrative aspect of the present disclosure, there is an illustrative effect that it is possible to provide a technology capable of improving accuracy of truth/falsity determination on a matter suggested in content.

### BRIEF DESCRIPTION OF DRAWINGS

FIG. 1 is a block diagram illustrating a configuration of an information processing apparatus according to the present disclosure;

FIG. 2 is a flowchart illustrating a flow of a determination method according to the present disclosure;

FIG. 3 is a block diagram illustrating a configuration of another information processing apparatus according to the present disclosure;

FIG. 4 is a diagram illustrating an example of truth/falsity determination using a large language model (LLM);

FIG. 5 is a diagram illustrating an example of a report generated by a report creation unit;

FIG. 6 is a diagram illustrating an example of a user interface (UI) screen that receives a condition change;

FIG. 7 is a flowchart illustrating an example of processing executed by the information processing apparatus illustrated in FIG. 3;

FIG. 8 is a flowchart illustrating an example of redetermination processing;

FIG. 9 is a flowchart illustrating another example of redetermination processing; and

FIG. 10 is a block diagram illustrating a configuration of a computer that functions as the information processing apparatus according to the present disclosure.

### EXAMPLE EMBODIMENT

Hereinafter, example embodiments of the present invention will be described. However, the present invention is not limited to the illustrative example embodiments described below, and various modifications can be made within the scope described in the claims. For example, example embodiments obtained by appropriately combining technologies (some or all of things or methods) adopted in the following illustrative example embodiments can also be included in the scope of the present invention. Example embodiments obtained by appropriately omitting some of the technologies adopted in the following illustrative example embodiments can also be included in the scope of the present invention. Effects mentioned in the following illustrative example embodiments are examples of effects expected in the illustrative example embodiments, and do not define the extension of the present invention. In other words, example embodiments that do not achieve the effects mentioned in the following illustrative example embodiments can also be included in the scope of the present invention.

### [First Illustrative Example Embodiment]

A first illustrative example embodiment that is an example embodiment of the present invention will be described in detail with reference to the drawings. The present illustrative example embodiment is a basic form of each illustrative example embodiment described below. Note that an application range of each technology adopted in the present illustrative example embodiment is not limited to the present illustrative example embodiment. In other words, each technology adopted in the present illustrative example embodiment can also be adopted in the other illustrative example embodiments included in the present disclosure within a range in which no particular technical problems occur. Each technology illustrated in the drawings referred to for describing the present illustrative example embodiment can also be adopted in other illustrative example embodiments included in the present disclosure within a range in which no particular technical problems occur.

### (Configuration of Information Processing Apparatus)

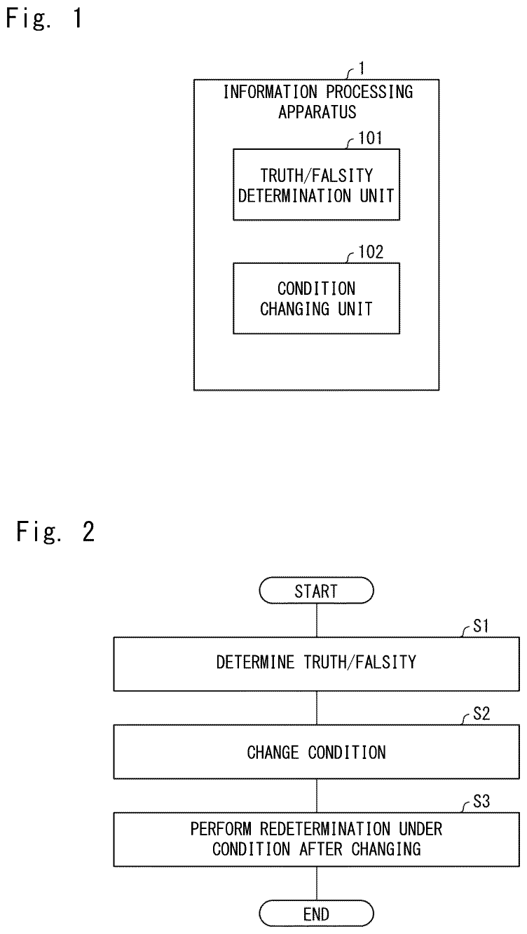

A configuration of an information processing apparatus 1 will be described with reference to FIG. 1. FIG. 1 is a block diagram illustrating a configuration of the information processing apparatus 1. As illustrated in FIG. 1, the information processing apparatus 1 includes a truth/falsity determination unit 101 and a condition changing unit 102.

The truth/falsity determination unit 101 determines truth/falsity of a matter suggested in content. As will be described in a second illustrative example embodiment, which will be described later, the truth/falsity determination unit 101 determines truth/falsity of a suggested matter extracted from a news article on the Internet.

The “content” includes at least any one of a text element and a non-text element. The “non-text element” indicates data in a format other than the text format, and examples thereof include image data, video data, and audio data. The content may include multiple kinds of non-text elements. Also, the content may include multiple non-text elements of a specific type.

The “suggested matter” is an opinion, truth or falsity of which can be determined. In other words, the suggested matter corresponds to concepts or information that are assumed to be recognized by a recipient of the content upon receiving the content.

For example, the truth/falsity determination unit 101 may perform the truth/falsity determination using an LLM. In this case, the truth/falsity determination unit 101 generates a prompt indicating that text indicating a matter suggested in content and information as evidence for the truth/falsity determination are used as inputs and a truth/falsity determination result of the suggested matter is used as an output, and inputs the prompt to the LLM. The truth/falsity determination result may be indicated by a binary value of “true” or “false” or may be indicated by evaluation results of a plurality of levels such as “true”, “slightly true”, “slightly false”, and “false”. A degree of likelihood to be “true” may be indicated by a numerical value (such as 0 to 100) as the truth/falsity determination result.

Examples of the information as evidence for the truth/falsity determination include information existing on the Internet (external information), information stored in the information processing apparatus 1 or a private network where the information processing apparatus 1 is present (internal information), and the like.

The truth/falsity determination unit 101 may access an LLM service provided on a cloud via a communication network and use the LLM service, or may use an LLM processing unit built into the information processing apparatus 1.

The condition changing unit 102 changes the condition of the truth/falsity determination by the truth/falsity determination unit 101. For example, the condition changing unit 102 changes a search condition of verification information to be used as evidence for the truth/falsity determination as will be described later in a second illustrative example embodiment.

Any method of changing the condition of the truth/falsity determination may be adopted. For example, the condition changing unit 102 may decide a matter to be changed in the condition of the truth/falsity determination using an LLM. In this case, it is only necessary to input various kinds of information (for example, information indicating a condition before the change) related to the change in condition to the LLM and to cause the LLM to output information indicating how the condition is to be changed.

Note that since the LLM is a probabilistic model, the output may be different even in a case of the same settable condition. In this manner, adopting the same settable condition as that of previous determination is also included in a range of changing the condition of the truth/falsity determination in the case where the probabilistic model is used in the truth/falsity determination. An LLM service provided on a cloud may be used, or an LLM processing unit built into the information processing apparatus 1 may be used, as described above. Note that the LLM used for the truth/falsity determination and the LLM used for the changing of the condition may be the same model or may be different models.

After the condition changing unit 102 changes the condition as described above, the truth/falsity determination unit 101 redetermines truth/falsity of the matter suggested in the content under the condition after the changing by the condition changing unit 102.

As described above, the information processing apparatus 1 employs a configuration including the truth/falsity determination unit 101 that determines truth/falsity of a matter suggested in content and a condition changing unit 102 that changes a condition of the truth/falsity determination, in which the truth/falsity determination unit 101 redetermines truth/falsity of the matter suggested in the content under the condition after the changing by the condition changing unit 102. Therefore, according to the information processing apparatus 1, an effect that it is possible to improve accuracy of the truth/falsity determination on a matter suggested in content is obtained. Also, according to the information processing apparatus 1, it is also possible to avoid making an incorrect decision based on the content including an incorrect matter.

### (Determination Program)

The functions of the information processing apparatus 1 described above may also be realized by a program. A determination program according to the present illustrative example embodiment causes a computer to function as the truth/falsity determination unit 101 that determines truth/falsity of a matter suggested in content and the condition changing unit 102 that changes a condition of the truth/falsity determination, in which the truth/falsity determination unit 101 redetermines truth/falsity of the matter suggested in the content under the condition after the changing by the condition changing unit 102. According to the determination program, an effect that it is possible to improve accuracy of truth/falsity determination on a matter suggested in content is obtained.

### (Determination Method)

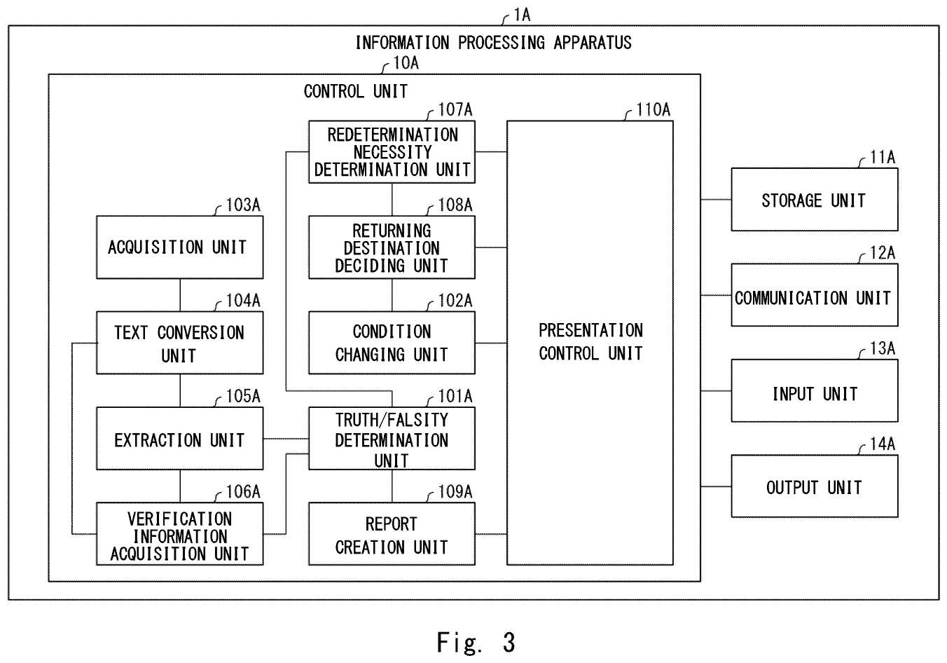

A flow of a determination method according to the present illustrative example embodiment will be described with reference to FIG. 2. FIG. 2 is a flowchart illustrating the flow of the determination method. An executing entity of each step in the determination method may be a processor included in the information processing apparatus 1 or may be a processor included in another apparatus, or executing entities of the steps may be processors provided in mutually different apparatuses.

In S1 (truth/falsity determination processing), at least one processor determines truth/falsity of a matter suggested in content.

In S2 (condition changing processing), at least one processor changes a condition of the truth/falsity determination.

In S3 (redetermination processing), at least one processor redetermines truth/falsity of the matter suggested in the content under the condition after the changing.

As described above, a verification method according to the present illustrative example embodiment employs a method of executing, at least by one processor, truth/falsity determination processing of determining truth/falsity of a matter suggested in content, condition changing processing of changing a condition of the truth/falsity determination, and processing of redetermining truth/falsity of the matter suggested in the content under the condition after the changing. Therefore, according to the determination method in the present example embodiment, an effect that it is possible to improve accuracy of truth/falsity determination on a matter suggested in content is obtained.

### [Second Illustrative Example Embodiment]

A second illustrative example embodiment that is an example of an example embodiment of the present invention will be described in detail with reference to the drawings. Components having the same functions as the components described in the above-described illustrative example embodiment will be denoted by the same reference numerals, and the description thereof will be appropriately omitted. Note that an application range of each technology adopted in the present illustrative example embodiment is not limited to the present illustrative example embodiment. In other words, each technology adopted in the present illustrative example embodiment can also be adopted in the other illustrative example embodiments included in the present disclosure within a range in which no particular technical problems occur. In addition, each technology illustrated in each of the drawings referred to for describing the present illustrative example embodiment can be employed in other illustrative example embodiments included in the present disclosure within a range in which no particular technical problems occur.

### (Configuration of Information Processing Apparatus 1A)

A configuration of an information processing apparatus 1A according to the present illustrative example embodiment will be described based on FIG. 3. FIG. 3 is a block diagram illustrating the configuration of the information processing apparatus 1A. The information processing apparatus 1A includes a control unit 10A that performs overall control on each unit in the information processing apparatus 1A and a storage unit 11A that stores various kinds of data used in the information processing apparatus 1A. Furthermore, the information processing apparatus 1A includes a communication unit 12A for the information processing apparatus 1A to communicate with other apparatuses, an input unit 13A that receives inputs to the information processing apparatus 1A, and an output unit 14A for the information processing apparatus 1A to output data. Also, the control unit 10A includes a truth/falsity determination unit 101A, a condition changing unit 102A, an acquisition unit 103A, a text conversion unit 104A, an extraction unit 105A, a verification information acquisition unit 106A, a redetermination necessity determination unit 107A, a returning destination deciding unit 108A, a report creation unit 109A, and a presentation control unit 110A. The following description will be started with the acquisition unit 103A.

The acquisition unit 103A acquires content that is a target of determination on truth/falsity of a suggested matter. For example, the acquisition unit 103A receives information for specifying content that is a target of determination on truth/falsity of a suggested matter from a user via the communication unit 12A or the input unit 13A and acquires the content. In addition, the acquisition unit 103A may automatically acquire the content without manual operation. Examples of the information for specifying the content include uniform resource locator (URL) information indicating a specific page on the Internet, information for specifying a specific post in a specific social networking service (SNS), and information indicating a storage location of a specific content file including content data.

The target content may be any content as long as the content includes some suggested matter. For example, the target content may be a news article on the Internet, a message posted on an SNS or the like, audio/video data at the time of investigation by the police, or the like. Furthermore, the target content may be limited to content in a specific field. For example, it is possible to verify truth/falsity of a specialized matter in the medical field by limiting the target content to articles in the medical field. For example, it is possible to verify truth/falsity of a matter related to healthcare by limiting the target content to healthcare-related documents.

The text conversion unit 104A converts a non-text element included in the content as a target of determination on truth/falsity of a suggested matter into text. Here, the text conversion unit 104A converts the non-text element included in the content acquired by the acquisition unit 103A into text. For example, the text conversion unit 104A converts an image included in a news article on the Internet into text.

In a case where image data is included in content, examples of the information converted into text by the text conversion unit 104A include information for specifying a person included in the image, information indicating a state of the person, information for specifying an object, information indicating a state of the object, information indicating a location, and information indicating a time.

Furthermore, in a case where audio data is included in the content, examples of the information converted into text by the text conversion unit 104A include a matter included in speech of a person included in the audio, information of environmental sound, and information of music. Furthermore, in a case where video data is included in the content, examples of the information converted into text by the text conversion unit 104A include various kinds of information corresponding to the above-described image data in regard to the image included in the video and various kinds of information corresponding to the above-described audio data in regard to the audio included in the video.

Examples of a method for converting a matter included in an image into text include bootstrap language image pre-training (BLIP). Furthermore, examples of a method of converting a matter included in a video into text include Video-LLaVa. Examples of a method of converting a matter included in audio into text include Whisper. Furthermore, examples of a method of extracting text in a video include an optical character recognition (OCR) technology such as vision transformer for fast and efficient scene text recognition (ViTSTR). Moreover, text may be generated from a non-text element using a vision language model or the like that receives a plurality of modalities as inputs and generates text, for example.

Furthermore, the text conversion unit 104A may analyze the non-text element from some viewpoint by artificial intelligence (AI) instead of the matter itself indicated by the non-text element and convert the analysis result into text. For example, the text conversion unit 104A may convert the result into text using AI that specifies the location based on a scenery included in an image or a video. Furthermore, the text conversion unit 104A may convert the determination result into text using AI that determines whether the image, the video, and the audio are media generated by deep fake or media generated by generative AI.

In other words, the text conversion unit 104A may generate text information based on at least one of the information obtained by converting a matter indicated by a non-text element into text and information obtained by converting a result of analyzing a non-text element from some viewpoint into text.

The extraction unit 105A extracts a matter suggested in the content from the non-text element that has been converted into text by the text conversion unit 104A and/or a text element included in the content. For example, the extraction unit 105A extracts a matter suggested in a news article on the Internet from text obtained by converting an image included in the news article.

Specifically, the extraction unit 105A generates a prompt indicating that text generated by the text conversion unit 104A in regard to one or more non-text elements included in content and/or text elements included in the content are used as an input and a suggested matter is used as an output, and inputs the prompt to a language model. Here, a plurality of suggested matters may be assumed depending on content, the extraction unit 105A may generate a prompt that allows the plurality of suggested matters to be output.

As the above-described language model, a model that has machine learned alignment of components (such as words) in sentences and alignment of sentences in articles, for example, may be applied. From the viewpoint of obtaining highly accurate outputs, it is particularly preferable to use an LLM generated by machine learning using a large-scaled language corpus. For example, a generative pre-trained transformer (GPT) that outputs a sentence including an input character sequence by predicting a character sequence having a high probability of following the input character sequence can be used as the LLM used for extracting a suggested matter. As other examples, it is also possible to use a text-to-text transfer transformer (T5), bidirectional encoder representations from transformers (BERT), a robustly optimized BERT approach (ROBERTa), efficiently learning an encoder that classifies token replacements accurately (ELECTRA), or the like as the LLM used for extracting a suggested matter.

As an example of the above-described prompt, the following matter can be listed. “Text inputs as a combination of text, images, audio, and videos will be given. Your job is to comprehensively evaluate the given text inputs and accurately determine and extract a suggestion included in the inputs. The suggestion here is an opinion, truth/falsity of which can be determined. If a plurality of suggestions are included in the input, please extract them all.”

In addition, the above prompt may include at least one of text corresponding to an image that has been converted into text by the text conversion unit 104A, text corresponding to a video, and text corresponding to audio. In a case where a text element is included in the content, the text element is also included in the prompt. The matter suggested in the content is output from the LLM by such a prompt being input to the LLM.

The extraction unit 105A may access an LLM service provided on a cloud via a communication network and use the LLM service, or may use an LLM processing unit built into the information processing apparatus 1A. Then, the extraction unit 105A extracts the output result from the LLM as a suggested matter.

The verification information acquisition unit 106A acquires verification information serving as a basis of truth/falsity determination by the truth/falsity determination unit 101A based on at least one of text generated by the text conversion unit 104A, text as a text element included in content acquired by the acquisition unit 103A, and a non-text element included in the content acquired by the acquisition unit 103A.

The verification information may be any information that can be used for the truth/falsity determination. In addition, the data format of the verification information is not particularly limited. Also, multi-modal data including data in a plurality of data formats may be used as the verification information. For example, the verification information acquisition unit 106A may search a website based on the text acquired from at least either the text conversion unit 104A or the acquisition unit 103A and acquire text data, image data, audio data, and video data included in the website included in the search result as multimodal verification information. In addition, the verification information acquisition unit 106A may search for images, audio, and videos on the Internet based on the text acquired from at least either the text conversion unit 104A or the acquisition unit 103A and acquire image data, audio data, and video data as search results. In addition, any target may be searched for. For example, the verification information acquisition unit 106A may perform searching on a predetermined database, data lake, or the like as a target.

In addition, the verification information acquisition unit 106A may provide an instruction to generate a word or a search expression to be used for the searching to the LLM based on the text acquired from at least either the text conversion unit 104A or the acquisition unit 103A. Then, the verification information acquisition unit 106A may perform the above searching using the word or the search expression generated by the LLM.

Also, the verification information acquisition unit 106A may perform the searching on the website in a multimodal manner based on the images, the audio, or the videos as non-text elements acquired by the acquisition unit 103A and acquire the text data, the image data, the audio data, and the video data included in the website included in the result of the searching as multimodal verification information. In addition, the verification information acquisition unit 106A may search for images, audio, and videos on the Internet similar to each piece of modal data and acquire image data, audio data, and video data as search results via the acquisition unit 103A based on the images, the audio, and the videos as non-text elements acquired by the acquisition unit 103A.

In addition, the verification information acquisition unit 106A may acquire the verification information from the search results from the top to a predetermined rank in the above-mentioned external information search.

Furthermore, the verification information acquisition unit 106A may acquire verification information input by a user of the information processing apparatus 1A via the communication unit 12A or the input unit 13A. Furthermore, the verification information acquisition unit 106A may acquire, as the verification information, internal information such as data stored in advance in the storage unit 11A of the information processing apparatus 1A or data stored in a private network where the information processing apparatus 1A is present.

In a case where the internal information is used as the verification information, the verification information acquisition unit 106A does not need to perform the searching. Note that the verification information acquisition unit 106A may search for internal information that is to be used as the verification information. As a searching method, a method similar to that in a case where external information is used as verification information can be applied.

In addition, the verification information acquisition unit 106A may perform both the searching for the external information described above and the acquisition of the internal information described above. In other words, the verification information acquisition unit 106A may use both the information acquired by the searching and the information acquired without the searching as the verification information.

Furthermore, the non-text elements included in the multimodal verification information acquired by the verification information acquisition unit 106A as described above are converted into text by the text conversion unit 104A. Here, in a case where the text obtained through the conversion into text is too long or redundant, processing such as inputting the text to LLM to summarize the text may be performed. Furthermore, in a case where there are a plurality of text elements included in the verification information acquired by the verification information acquisition unit 106A as described above, they may be combined into one piece of text. Similarly, in a case where there are a plurality of pieces of text generated by the text conversion unit 104A, they may be combined into one piece of text. Moreover, the text element included in the verification information and the text generated by the text conversion unit 104A may be combined into one piece of text. In these cases, truth/falsity determination is performed using the integrated text. Note that any integration method may be used. For example, the integration may be performed in a form in which descriptions of the text are simply listed or may be performed in a form in which the LLM is caused to generate a summary of matters included in the plurality of pieces of text.

The truth/falsity determination unit 101A determines truth/falsity of a suggested matter extracted by the extraction unit 105A. Here, the truth/falsity determination unit 101A first acquires the text indicating the matter suggested in the content as a target of the truth/falsity determination, which has been extracted by the extraction unit 105A. Furthermore, the truth/falsity determination unit 101A acquires verification information serving as a basis for the truth/falsity determination from the verification information acquisition unit 106A.

Specifically, the truth/falsity determination unit 101A inputs text indicating the matter suggested in the content and the verification information for verifying truth/falsity of the suggested matter to the LLM that is a language model after machine learning, causes the LLM to generate an output indicating validity of the suggested matter, and determines truth/falsity of the suggested matter based on the output. In other words, the truth/falsity determination unit 101A generates a prompt indicating that the text indicating the suggested matter extracted from the extraction unit 105A and the text as the verification information serving as a basis for the truth/falsity determination acquired from the verification information acquisition unit 106A are used as inputs and the truth/falsity determination result of the suggested matter is used as an output, and inputs the prompt to the LLM. The truth/falsity determination result may be indicated by a binary value of “true” or “false” or may be indicated by evaluation results of a plurality of levels such as “true”, “slightly true”, “slightly false”, and “false”. A degree of likelihood to be “true” may be indicated by a numerical value (such as 0 to 100) as the truth/falsity determination result.

The truth/falsity determination unit 101A may divide the text representing the suggested matter into a plurality of pieces, determine truth/falsity of each part, and comprehensively determine truth/falsity from each determination result.

As an example of the prompt, the following matter can be listed. “A suggested matter obtained from the content and evidence for determining truth/falsity of the suggested matter will be given. Your job is to determine whether the suggested matter is correct based on the evidence. Please select “fact” or “false” in the determination.”

In addition, the above-described prompt is caused to include the text indicating the suggested matter extracted from the extraction unit 105A and the text as the verification information serving as a basis for truth/falsity determination, which has been acquired from the verification information acquisition unit 106A. The truth/falsity determination result of the matter suggested in the content is output from the LLM by such a prompt being input to the LLM.

Note that the text input to the LLM may include, in addition to the text indicating the suggested matter, original text of the text. For example, it is assumed that the content as a target of the truth/falsity determination includes an image and first text. In addition, it is assumed that the text conversion unit 104A has generated second text from the image. Then, it is assumed that fourth text indicating the matter suggested in the content has been generated from third text obtained by combining the first text and the second text. In this case, the text input to the LLM at the time of the truth/falsity determination may include, in addition to the fourth text, at least any of the first to third text.

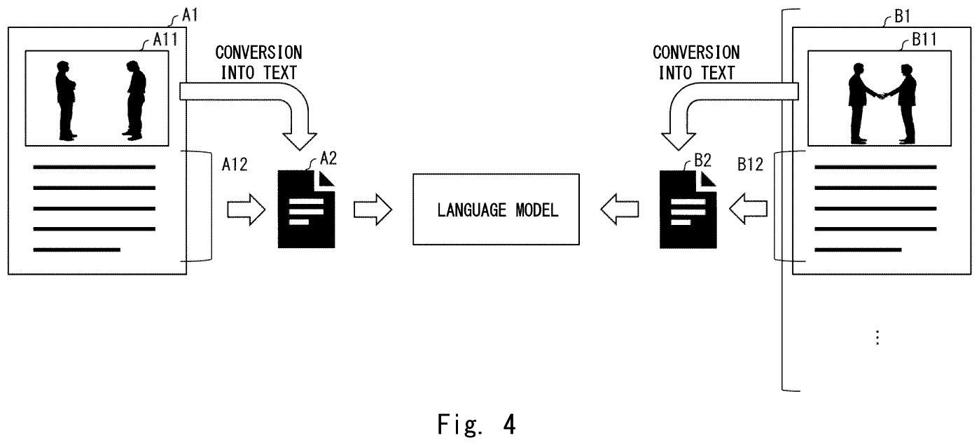

FIG. 4 is a diagram illustrating a truth/falsity determination example using an LLM (language model). In the example in FIG. 4, integrated text A2 obtained by integrating text generated by the text conversion unit 104A in relation to a non-text element A11 included in content A1 and a text element A12 included in content is generated. The integrated text A2 indicates a matter suggested in the content A1.

Both the generation of the text from the non-text element A11 and the generation of the integrated text A2 can be performed using an LLM. The LLM used for the processing may be the same as the LLM used for the truth/falsity determination or may be different therefrom. In particular, it is preferable to use a generation model in accordance with the data format of the non-text element A11 for the generation of the text from the non-text element A11. The same applies to generation of text from a non-text element B11 and generation of integrated text B2, which will be described later.

Furthermore, a plurality of pieces of verification information are used to determine truth/falsity of the matter suggested in the content A1 in the example in FIG. 4. Verification information B1, which is one of the plurality of pieces of verification information, includes the non-text element B11. Therefore, the text conversion unit 104A converts the non-text element B11 into text. Then, integrated text B2 as a combination of the text generated from the non-text element B11 and a text element B12 included in the verification information B1 is generated. The integrated text B2 indicates a matter described in the verification information B1. Note that although illustration is omitted, text indicating a matter in other verification information is also generated similarly to the verification information B1. The verification information that does not include any text element is used for verification as it is.

In the verification, the truth/falsity determination unit 101A inputs the integrated text A2 generated as described above and the integrated text B2 (and the text indicating the matter in other verification information) to the LLM. In this manner, a truth/falsity determination result is output from the LLM.

The redetermination necessity determination unit 107A determines whether to perform redetermination. In a case where the redetermination necessity determination unit 107A determines that redetermination is necessary, the truth/falsity determination unit 101A performs redetermination. Any method of determining the necessity of redetermination may be adopted. For example, the redetermination necessity determination unit 107A may determine that redetermination is necessary until the truth/falsity determination unit 101A performs redetermination a predetermined number of times, and may determine that the redetermination is not to be performed when the truth/falsity determination unit 101A performs the redetermination the predetermined number of times.

Furthermore, the redetermination necessity determination unit 107A may determine whether to perform redetermination using a determination result of the truth/falsity determination unit 101A, for example. In this manner, an effect that it is possible to appropriately determine whether to perform redetermination in accordance with the determination result of the truth/falsity determination unit 101A is obtained in addition to the effect achieved by the information processing apparatus 1.

For example, the redetermination necessity determination unit 107A may determine that redetermination is necessary until a result of truth/falsity determination performed by the truth/falsity determination unit 101A on the matter suggested in the content satisfies a predetermined condition. For example, it is assumed that the degree of likelihood to be “true” is indicated by a numerical value (such as 0 to 100) as the truth/falsity determination result of the truth/falsity determination unit 101A. In this case, the redetermination necessity determination unit 107A may determine that redetermination is to be performed when the numerical value is less than a threshold value and may determine that redetermination is not to be performed when the numerical value is equal to or greater than the threshold value.

In another example, it is assumed that the truth/falsity determination result of the truth/falsity determination unit 101A is indicated by evaluation results of a plurality of levels such as “true”, “slightly true”, “slightly false”, and “false”. In this case, the redetermination necessity determination unit 107A may determine that redetermination is to be performed and cause the truth/falsity determination unit 101A to perform redetermination when the truth/falsity determination result is “slightly true” or “slightly false”. On the other hand, the redetermination necessity determination unit 107A determines that redetermination is not to be performed when the truth/falsity determination result is “true” or “false”.

The redetermination necessity determination unit 107A may determine whether to perform redetermination using the LLM. In an example, the redetermination necessity determination unit 107A generates a prompt indicating that the result of truth/falsity determination performed by the truth/falsity determination unit 101A on the matter suggested in the content and/or a report (which will be described later) related to the truth/falsity determination result are used as inputs and the necessity of redetermination is used as an output, and inputs the prompt to the LLM. The redetermination necessity determination unit 107A can determine whether to perform redetermination based on the output of the LLM.

The redetermination necessity determination unit 107A can also determine whether to perform redetermination using in-context learning (ICL). ICL means that a LLM learns a new task from demonstration shown as an example at the time of inference. The redetermination necessity determination unit 107A can make a determination based on a determination criterion that is close to that of a human by including manually generated input/output cases in the prompt.

The redetermination necessity determination unit 107A may allow a person to determine the necessity of redetermination. For example, the redetermination necessity determination unit 107A may allow the user to input an instruction regarding whether to perform redetermination every time the truth/falsity determination unit 101A determines truth/falsity of the matter suggested in the content.

The returning destination deciding unit 108A decides from which of a series of processes when the previous truth/falsity determination result has been obtained the processing is to be started again in the redetermination of truth/falsity of the matter suggested in the content. The series of processes to obtain the truth/falsity determination result includes, for example, a process of extracting the matter suggested in the content by the extraction unit 105A, a process of acquiring verification information by the verification information acquisition unit 106A, a process of converting a non-text element into text by the text conversion unit 104A, and a process of determining truth/falsity by the truth/falsity determination unit 101A. The returning destination deciding unit 108A decides from which of the series of processes the processing is to be started again, when the truth/falsity determination unit 101A redetermines the matter suggested in the content.

For example, the returning destination deciding unit 108A can input the series of processes to a language model (for example, an LLM) after machine learning, cause the language model to generate an output indicating from which of the processes the processing is to be started again, and decide from which of the processes the processing is to be started again based on the output. Specifically, the returning destination deciding unit 108A generates a prompt indicating that the series of processes are used as inputs and a result indicating from which of the processes the processing is to be started again is used as an output, inputs the prompt to the LLM, and decides from which of the processes the processing is to be started again based on the output of the LLM.

As an example of the prompt, the following matter can be listed. “Text, suggestion thereof, a fact checking result of the suggestion, and information used for the fact checking will be given to you. Here, the fact checking is a work of determining truth/falsity of the suggestion. This work includes three processes, namely “suggestion extraction” of extracting the suggestion from the input, “evidence search” of generating an appropriate query from the suggestion in order to search for evidence, and “suggestion verification” of determining truth/falsity from the suggestion and the evidence. Your job is to review inadequacy of the fact checking from the given inputs and identify the processing (processes) to be done again from “suggestion extraction”, “evidence search”, and “suggestion verification.” Note that the returning destination is not limited to these three kinds and may include other processes, such as a process of converting a non-text element into text and a process of combining a plurality of pieces of text acquired/generated from the content or the verification information.

In addition, the above prompt includes text indicating the matter suggested in the content, the verification information for verifying truth/falsity of the suggested matter, and a verification result obtained by verifying truth/falsity of the suggested matter. The matter indicating from which of the processes the processing is to be started again is output from the LLM by such a prompt being input to the LLM. Note that ICL may also be used in a case where the LLM is applied to the decision of the returning destination similarly to the case where the LLM is applied to the above-described redetermination necessity determination.

In addition, the returning destination deciding unit 108A may include input/output logs of processing performed in the past in the prompt. More specifically, the returning destination deciding unit 108A may include at least either a prompt input to the LLM to decide the returning destination in the previous redetermination or an output obtained by the prompt to input data of the LLM for deciding the returning destination in the current redetermination in a case where redetermination has already been performed. Furthermore, the returning destination deciding unit 108A may include problems (such as a problem that the number of pieces of verification information and quality thereof are low, for example) in the previous truth/falsity determination, additional information to be used in the redetermination, and the like as reference information to decide the returning destination in the input data of the LLM for deciding the returning destination.

The returning destination deciding unit 108A may allow a person to designate the returning destination. For example, the returning destination deciding unit 108A allow the user to input an instruction related to the returning destination in the redetermination. The returning destination may be designated by text, a processing ID assigned in advance, or the like. In an example, the returning destination may be designated by “suggestion extraction” or “ID=1” for the process of extracting the matter suggested in the content, by “evidence search” or “ID=2” for the process of acquiring the verification information, and by “suggestion verification” or “ID=3” for the process of determining truth/falsity, or the like. Note that the returning destination is not limited to these three kinds as described above.

As described above, the information processing apparatus 1A includes the returning destination deciding unit 108A that decides from which of the series of processes to obtain a result of truth/falsity determination the processing is to be started again in the redetermination. Therefore, according to the information processing apparatus 1A, an effect that it is possible to decide from which of the processes the processing is to be started again in the redetermination is obtained in addition to the effect achieved by the information processing apparatus 1. Note that the returning destination may be automatically decided or the returning destination may be decided via the user as described above.

The condition changing unit 102A changes the condition of the truth/falsity determination. Any method of changing the condition may be adopted. For example, the condition changing unit 102A may decide a matter to be changed in the condition of the truth/falsity determination using a language model (for example, an LLM) after machine learning.

As described above, the suggestion extraction using the LLM and the like are performed in the series of processes to obtain the result of the truth/falsity determination. Here, the processing using the LLM can be generalized by an equation y=f(X, p, K) where y is an output of the LLM, X is a variable input to the LLM, p is a prompt input to the LLM, and K is a hyperparameter of the LLM. In other words, the output y of the LLM can be changed by changing at least any of X, p, and K in the processing using the LLM. Therefore, changing at least any of X, p, and K is equivalent to changing the condition of the truth/falsity determination in the processing using the LLM included in the series of processes to obtain the result of the truth/falsity determination. In addition, changing the output y of the LLM is also equivalent to changing the condition of the truth/falsity determination. Therefore, the condition changing unit 102A may change the condition of the truth/falsity determination by changing at least any of y, X, p, and K for at least any of the processing using the LLM in the series of processes to obtain the result of the truth/falsity determination.

A case where redetermination is performed by changing the condition of the suggestion verification, that is, a case where the returning destination in the redetermination is the suggestion verification, for example, will be considered. In this case, the input X to the LLM in the suggestion verification includes the text indicating the matter suggested in the content as a target of the truth/falsity determination, text indicating the matter included in the verification information as evidence for determining truth/falsity thereof, and the like. In addition, the output y from the LLM indicates the result of determining truth/falsity of the matter suggested in the content. Moreover, the prompt p is for providing an instruction to output the result of determining truth/falsity of the suggested matter. Furthermore, the parameter K is set in the LLM.

Therefore, the condition changing unit 102A can make the output y from the LLM in the redetermination different from the output in the previous determination by changing at least any of the input X such as the text indicating the matter suggested in the content, the text indicating the matter included in the verification information as the evidence for determining truth/falsity, and the like, the prompt p for providing an instruction to output the result of determining truth/falsity of the suggested matter, and the parameter K. The condition changing unit 102A can also change the output y.

Any method of deciding the matter to be changed in y, X, p, and K may be adopted. For example, the condition changing unit 102A may decide the matter to be changed using a language model (for example, an LLM) after machine learning. In a case where the condition of the suggestion verification is changed, for example, the following prompts (1) to (4) may be used. Note that the prompts (1) to (4) are prompts for causing the LLM to decide the matters to be changed in y, X, p, and K, respectively.

(1) “Your job is to determine and correct inadequacy of the fact checking result from given text, suggestion thereof, evidence information, and the fact checking result. [text]: {text} [suggestion]: {suggestion} [evidence]: {evidence} [fact checking result]: {fact checking result} [output]:” Note that text of the content as a target of the truth/falsity determination is input to {text} in the prompt, and text indicating the suggested matter extracted from the content is input to {suggestion}. Furthermore, text indicating a matter included in the verification information is input to {evidence}, and a result of the previous truth/falsity determination is input to {fact checking result}. The truth/falsity determination result after the changing is output from the LLM by the prompt being input to the LLM.

(2) “Your job is to determine inadequacy of the fact checking result from given text, suggestion thereof, evidence information, and a result of the fact checking on the suggestion and provide additional necessary evidence. [text]: {text} [suggestion]: {suggestion} [evidence]: {evidence} [fact checking result]: {fact checking result} [output]:” Additional evidence to be used for verification of the suggestion, that is, verification information is output from the LLM by the prompt being input to the LLM. In this manner, the condition changing unit 102A may cause the LLM to output the verification information to be added.

(3) “Your job is to determine inadequacy of the fact checking result from given text, suggestion thereof, evidence information, a result of suggestion fact checking performed by the LLM, and a prompt thereof and correct the prompt to improve the inadequacy. [text]: {text} [suggestion]: {suggestion} [evidence]: {evidence} [original prompt]: {prompt} [fact checking result]: {fact checking result} [output]:” The truth/falsity determination result after the changing is output from the LLM by the prompt being input to the LLM. Note that a prompt used for suggestion verification in the previous truth/falsity determination is input to {prompt} in the prompt. The prompt after the changing is output from the LLM by the prompt being input to the LLM.

(4) “Your job is to determine inadequacy of the fact checking result from given text, suggestion thereof, evidence information, a result of suggestion fact checking performed by the LLM, and an LLM parameter used at that time and correct the parameter to improve the inadequacy. [text]: {text} [suggestion]: {suggestion} [evidence]: {evidence} [original parameter]: {parameter} [fact checking result]: {fact checking result} [output]:” Note that a parameter value set in the LLM is input in suggestion verification of the previous truth/falsity determination to {parameter} in the prompt. The parameter value to be set in the LLM in the suggestion verification at the time of the redetermination is output from the LLM by the prompt being input to the LLM.

The condition changing unit 102A can change the condition of processes other than the suggestion verification by prompts similar to (1) to (4) above as long as the processing uses the LLM. Also, the condition changing unit 102A may decide the matter to be changed in the condition of the truth/falsity determination using the ICL. The condition changing unit 102A can include at least either a prompt input to a language model after learning in at least any of the series of processes to obtain a result of the truth/falsity determination or an output obtained by the prompt in input data of the language model in redetermination. In other words, the condition changing unit 102A may include a prompt of at least any of logs of an input to the LLM in the past and an output of the LLM in a new prompt. In this manner, it is possible to expect a response of the LLM in consideration of the past history, such as a response of not outputting the same output. The prompt may include only past logs of an input and an output in the same processing (process) or may include past logs of inputs and outputs in the entire processing (processes). Also, the prompt may include information that is not an output of the LLM but is generated in the processing (each process), such as a search result.

In addition, the condition changing unit 102A may designate past logs that depend on the past outputs of the LLM in designation of the “matter to be changed in condition of truth/falsity determination” in utilization of the past logs. For example, the condition changing unit 102A may specifically designate an error in past verification, provide an instruction regarding a viewpoint of reconsideration in a prompt, designate new verification information, and provide an instruction to use the new verification information.

As described above, the condition changing unit 102A may include at least either the prompt input to the language model after leaning in at least any of the series of processes to obtain the result of truth/falsity determination or the output obtained by the prompt in the input data of the language model in redetermination. In this manner, an effect that it is possible to appropriately change the condition in consideration of the past input and output histories of the language model is obtained in addition to the effect achieved by the information processing apparatus 1.

Also, the condition changing unit 102A may decide the matter to be changed in condition of the truth/falsity determination using a language model to decide the matter to be changed in condition of the truth/falsity determination, which is different from the language model after machine learning used in the series of processes to obtain the result of the truth/falsity determination. With this configuration, it is possible to decide a matter to be changed in condition of the truth/falsity determination using the language model optimized for the application of changing the condition of the truth/falsity determination.

As described above, the condition changing unit 102A may decide the matter to be changed in condition of the truth/falsity determination using the language model after machine learning. In this manner, an effect that it is possible to automatically decide the matter to be changed in condition of the truth/falsity determination without intervention of the user is obtained in addition to the effect achieved by the information processing apparatus 1.

As described above, the condition changing unit 102A may decide the matter to be changed in condition of the truth/falsity determination using a language model to decide the matter to be changed in condition of the truth/falsity determination, which is different from the language model after machine learning used in the series of processes to obtain a result of the truth/falsity determination. In this manner, it is also possible to use a language model optimized to decide the matter to be changed in condition of the truth/falsity determination, for example. Therefore, an effect that it is possible to decide the matter to be changed in condition of the truth/falsity determination with high accuracy is obtained in addition to the effect achieved by the information processing apparatus 1.

Additionally, the condition changing unit 102A may decide the matter to be changed in condition of the truth/falsity determination based on a user's input. As described above, the processing using the LLM can be generalized by an equation y=f(X, p, K) where y is an output of the LLM, X is a variable input to the LLM, p is a prompt input to the LLM, and K is a hyperparameter of the LLM. Therefore, the condition changing unit 102A may allow the user to designate the matter to be changed in at least any of X, p, and K in the equation and apply the designated matter to be changed as a condition of the redetermination. Also, the condition changing unit 102A may allow the user to designate the matter to be changed in y in the equation and apply the designated matter to be changed as a condition of the redetermination.

Furthermore, the condition changing unit 102A can also receive designation of adding X2 to an input X1 used in the previous truth/falsity determination, in regard to X in the equation. Furthermore, it is also possible to prepare a plurality of templates for the prompt to be input to the LLM in the processing and to allow the user to select a desired template, in regard to the prompt p. Moreover, the condition changing unit 102A can also receive designation of adding a new prompt p2 to a prompt p1 used in the previous truth/falsity determination.

In this manner, the condition changing unit 102A may change the prompt to be input to the language model after learning used in at least any of the series of processes to obtain a result of the truth/falsity determination. In this manner, an effect that it is possible to improve the redetermination result by utilizing a potential of the language model is obtained in addition to the effect achieved by the information processing apparatus 1. Note that the prompt may be automatically changed as described above.

In regard to the hyperparameter set in the LLM used in the processing, the condition changing unit 102A may receive designation of a hyperparameter (such as a temperature) related to sentence creation, for example. Furthermore, in a case where verification information has been searched for in the previous truth/falsity determination, the condition changing unit 102A may change a parameter related to the searching, such as an application programming interface (API) used at the time of the searching or the number of searches.

In addition, the condition changing unit 102A may receive an input of text including at least any of y, X, p, and K, that is, a document describing the matter to be changed. In this case, the condition changing unit 102A extracts at least any of y, X, p, and K from the input text and changes the condition based on the extracted matter.

In this manner, the condition changing unit 102A may receive the input of text indicating the matter to be changed in the condition and decide the condition of the redetermination by reflecting the matter to be changed extracted from the text. In this manner, an effect that it is possible to enhance a degree of freedom in input matters and to reduce a burden on the user for the inputting is obtained in addition to the effect achieved by the information processing apparatus 1.

The report creation unit 109A generates a report including a result of determining truth/falsity of the suggested matter and basis information indicating a basis of the determination result. For example, the report creation unit 109A may input description of a verification target and information indicating a verification process in addition to the determination result of the truth/falsity determination unit 101A to the LLM and cause the LLM to generate a report including the description of the verification target, the verification process, the verification result, and the reason therefor. The generated report is presented to the user by the presentation control unit 110A.

Furthermore, the truth/falsity determination unit 101A may cause the LLM to generate a report including the aforementioned basis information in addition to the result of the truth/falsity determination, instead of providing the report creation unit 109A. As an example of the prompt in this case, the following matter can be listed. “An input as a combination of text, images, audio, and videos, suggestion included in the input, evidence to determine truth/falsity of the suggestion, and description of details of evidence search will be given. Your job is to determine whether the suggestion of the input is correct based on the evidence and generate a report. Please include three items “verification target”, “verification process”, and “determination result” in the report and explain an input and suggestion thereof in “verification target”. Please explain, in the sentence form, the process of the fact checking that you carried out in “verification process”. Please select and determine “fact” or “fake” as a determination result of the fact checking in “determination result”. Please explain the reason for the determination in detail.”

Also, the above prompt is caused to include text generated by the text conversion unit 104A, text indicating the suggested matter extracted by the extraction unit 105A, text explaining a matter searched by the verification information acquisition unit 106A, and text as verification information serving as a basis of truth/falsity determination acquired from the verification information acquisition unit 106A. A report indicating the result of determining truth/falsity of the matter suggested in the content and the basis information is output from the LLM by such a prompt being input to the LLM.

Note that it is possible to cause the LLM to generate the text explaining the searched matter by inputting various kinds of information indicating the searched matter (various kinds of information used in the process of searching) to the LLM. It is also possible to cause the LLM to generate an explanatory sentence of the search result. As the text explaining the searched matter, the word (search word) or the search expression used in the searching, text indicating the search target, or the like may be used.

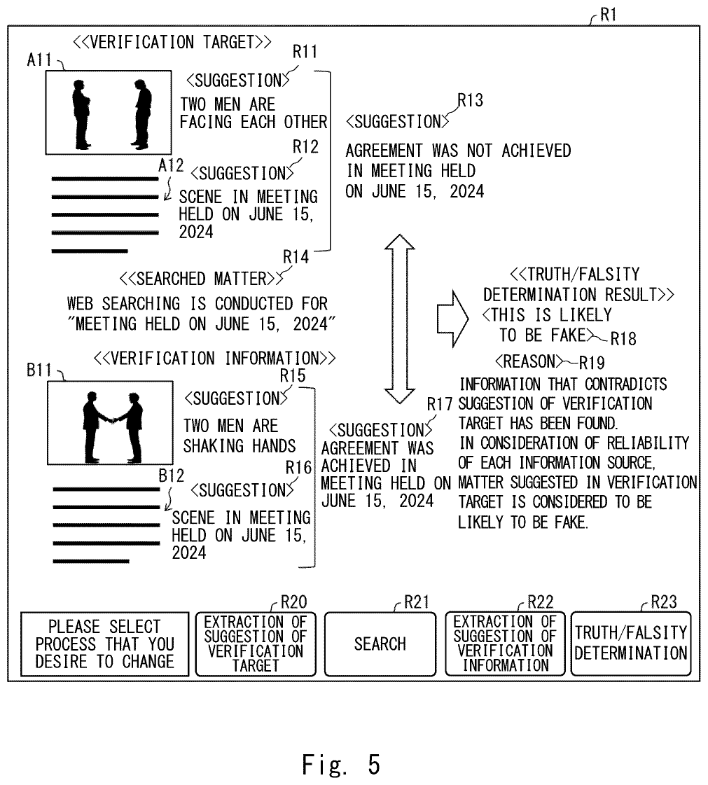

FIG. 5 illustrates an example of the report generated by the report creation unit 109A. In the verification target field in the report R1 illustrated in FIG. 5, an image corresponding to the non-text element A11, a text element A12, a suggestion R11 generated based on the non-text element A11, and a suggestion R12 generated based on the text element A12 are shown in regard to content A1 as a target of truth/falsity determination. Also, a suggestion R13 corresponding to the content A1 generated based on the suggestion R11 and the suggestion R12 is shown.

In addition, the report R1 indicates a searched matter R14 when the verification information B1 is acquired. In the field for the verification information acquired based on the searched matter R14, an image corresponding to a non-text element B11, a text element B12, a suggestion R15 generated based on the non-text element B11, and a suggestion R16 generated based on the text element B12 are shown in relation to the verification information B1. Also, a suggestion R17 corresponding to the verification information B1 generated based on the suggestion R15 and the suggestion R16 is shown.

Furthermore, a truth/falsity determination result R18 and a reason R19 for the truth/falsity determination result are shown in the field for the truth/falsity determination result output from the LLM by using the suggestion R13 corresponding to the content A1 and the suggestion R17 corresponding to the verification information B1 as inputs.

Note that although the arrangement position of each field for “verification process” and the flow of the verification process by arrows and the like are illustrated in the example illustrated in FIG. 5, the verification process is not limited to such representation and may alternatively be described in text.

The report creation unit 109A may generate such a report by inputting a prompt for providing an instruction to create a report including the above items to the LLM. In addition, the report creation unit 109A may generate an entry described in each item by inputting a prompt for providing an instruction to generate the entry to be described in each item to the LLM. For example, the LLM is caused to generate the reason R19 in FIG. 5 by inputting the truth/falsity determination result and the verification information to the LLM. In this case, the report creation unit 109A may generate the report by combining the generated entries to be described.

Also, the report creation unit 109A may generate a report including only the result of determining truth/falsity of the suggested matter. The report creation unit 109A may generate a report including the basis information indicating the basis of the determination result in response to an instruction from the user after generating the report including only the result of determining truth/falsity of the suggested matter. Furthermore, the report creation unit 109A may output how much priority the truth/falsity determination unit 101A has placed on each piece of the data acquired as the verification information. This may be acquired by the report creation unit 109A inquiring of the LLM.

Furthermore, returning destination selection buttons R20 to R23 that are display objects to receive designation of the returning destination at the time of the redetermination from among the series of processes to obtain the result of the truth/falsity determination are shown in the report R1. Specifically, the returning destination selection button R20 is a button to set extraction of suggestion of the verification target as the returning destination. The returning destination selection button R21 is a button to set searching of verification information as the returning destination. The returning destination selection button R22 is a button to set extraction of suggestion of verification information as the returning destination. The returning destination selection button R23 is a button to set truth/falsity determination as the returning destination. It is only necessary for the user to decide the returning destination after checking the details of the report R1 and to perform an operation of selecting the returning destination selection button corresponding to the decided returning destination.

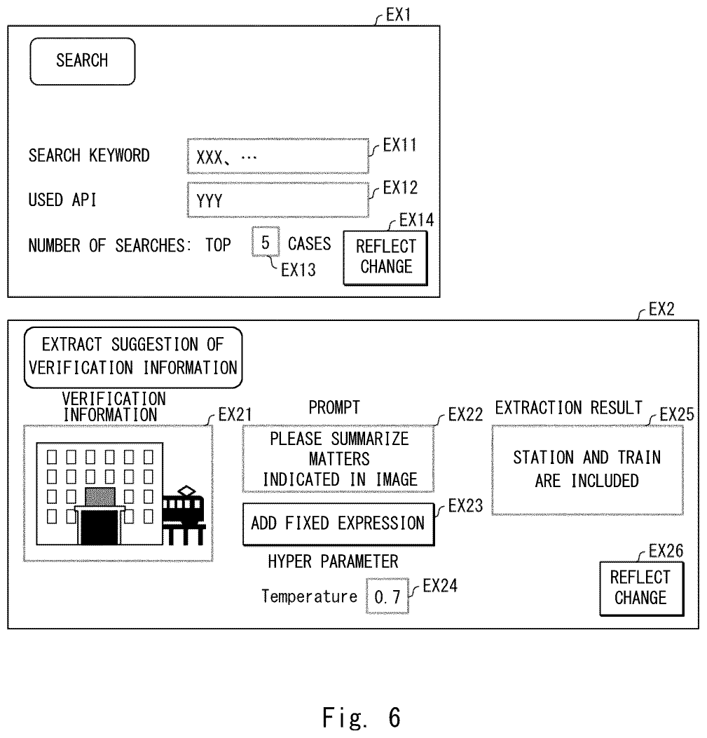

In a case where the returning destination is selected as described above, the presentation control unit 110A may display a UI screen for changing various conditions at the selected returning destination. FIG. 6 is a diagram illustrating an example of the UI screen for receiving a change in condition. More specifically, FIG. 6 illustrates a UI screen EX1 for changing a search condition and a UI screen EX2 for changing a condition of suggestion extraction from verification information. The UI screen EX1 is displayed when the returning destination selection button R21 in FIG. 5 is selected, for example. Also, it is assumed that the UI screen EX2 is displayed when the returning destination selection button R22 in FIG. 5 is selected, for example. Note that the UI screen as in FIG. 6 may be displayed to allow the user to manually change the condition in the automatically decided returning destination in a case where the returning destination is automatically decided without any user's operation.

The UI screen EX1 includes a search keyword input field EX11, a used API input field EX12, and a search number input field EX13. The presentation control unit 110A preferably causes information indicating the matter searched in the previous truth/falsity determination to be displayed in these fields when the display of the UI screen EX1 is started. This is because the user can change the search condition in consideration of the matter searched in the previous truth/falsity determination.

In addition, the UI screen EX1 includes a correction reflection button EX14. The user can reflect an input matter to the redetermination by putting desired inputs to the search keyword input field EX11, the used API input field EX12, and/or the search number input field EX13 and then selecting the correction reflection button EX14.

The UI screen EX2 includes a verification information display field EX21, a prompt input field EX22, a fixed expression addition button EX23, a hyperparameter input field EX24, and an extraction result display field EX25 in relation to suggestion extraction from the verification information. Note that in a case where a plurality of pieces of verification information are used, similar matters are displayed for each piece of the verification information. The presentation control unit 110A preferably causes information indicating the suggested matter extracted in the previous truth/falsity determination to be displayed in these fields when the display of the UI screen EX2 is started.

The fixed expression addition button EX23 is a display object to add a fixed expression to the prompt. In a case where an operation of selecting the fixed expression addition button EX23 is performed, the presentation control unit 110A may present a plurality of candidates for the fixed expression to be added and allow the user to select a fixed expression to be added from among the candidates. This enables even a user who does not have specialized knowledge about the prompt to appropriately correct the prompt. Examples of the fixed expression include “Please explain in more detail” and “Please change the target of interest”. Furthermore, the presentation control unit 110A may present a template such as “Please explain {target} in detail”, for example, to the user and may allow the user to input a target to be explained in detail to the part {target}.

In addition, the UI screen EX2 also includes a correction reflection button EX26 similarly to the UI screen EX1. The user can reflect input matters to the redetermination by putting desired inputs to the verification information display field EX21, the prompt input field EX22, the fixed expression addition button EX23, a hyperparameter input field EX24, and/or the extraction result display field EX25 and then selecting the correction reflection button EX26.

As a UI screen that receives a change in condition of the processing using the LLM, a UI screen that is substantially similar to the UI screen EX2 in FIG. 6 can be adopted. In a case where an LLM is used to extract suggestion from content as a target of the truth/falsity determination, for example, the presentation control unit 110A may present a prompt used for the extraction of the suggestion, a hyperparameter set at the time of the extraction, and an extraction result to the user. Then, the condition changing unit 102A may receive correction of at least any of the presented prompt, hyper parameter, and extraction result.

As described above, the presentation control unit 110A presents the report generated by the report creation unit 109A to the user. Furthermore, the presentation control unit 110A may present the series of processes to determine truth/falsity of the matter suggested in the content along with information indicating details of the processing in each process to the user as described above. In this case, the condition changing unit 102A receives user's designation of the returning destination from among the presented series of processes and decides the designated returning destination as a returning destination in the redetermination.

Furthermore, in a case where designation of the condition to be applied at the time of the redetermination is received, the presentation control unit 110A presents the condition before the changing by the condition changing unit 102A to the user. In this case, the condition changing unit 102A receives user's designation of a matter to be changed in the presented condition as a target and decides the condition of the redetermination by reflecting the designated matter to be changed.

Once truth/falsity of the matter suggested in the content is redetermined by applying the condition after the changing by the condition changing unit 102A, the presentation control unit 110A presents a result of the redetermination to the user. For example, the presentation control unit 110A may present a report regenerated by the report creation unit 109A to the user similarly to the previous determination.

### (Determination Method)

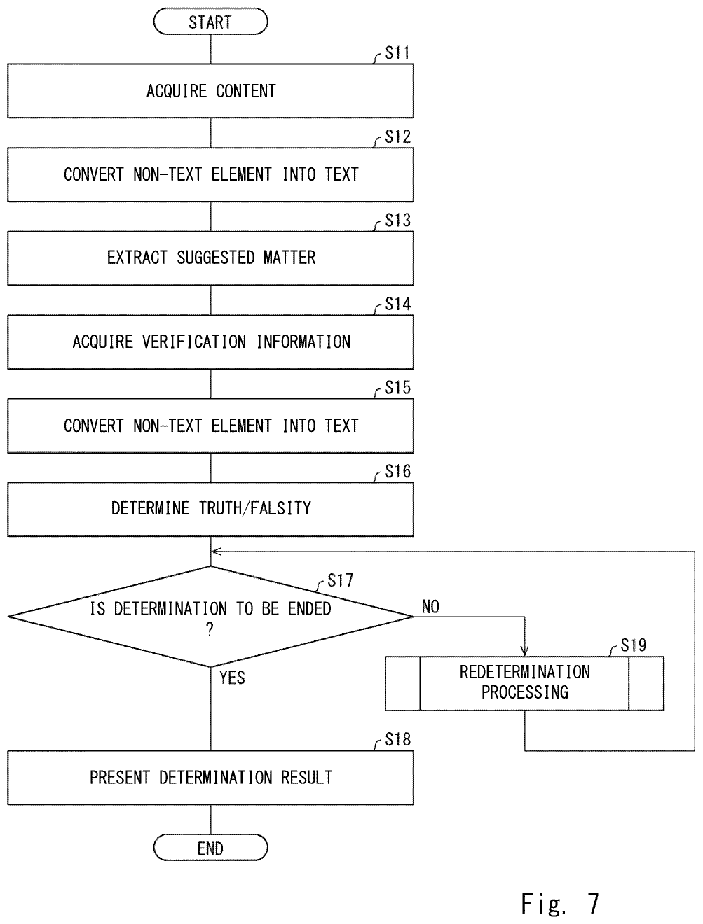

A flow of processing executed by the information processing apparatus 1A will be described with reference to FIG. 7. FIG. 7 is a flowchart illustrating an example of the processing performed by the information processing apparatus 1A. FIG. 7 includes the processing in the determination method according to the present illustrative example embodiment.

In S11, the acquisition unit 103A acquires content as a target of determination of truth/falsity of a suggested matter. In S12, the text conversion unit 104A converts a non-text element included in the content acquired in S11 into text. Note that in a case where the content acquired in S11 includes a text element and a non-text element, the text conversion unit 104A may integrate the text element and the non-text element, which has been converted into text, and generate one piece of text.

In S13, the extraction unit 105A extracts the matter suggested in the content from the non-text element, which has been converted into text by the text conversion unit 104A in S12, and the text element included in the content acquired in S11. In this case, the extraction unit 105A may regard each of the suggested matter extracted from the non-text element, which has been converted into text, and the suggested matter extracted from the text element as a matter suggested in the content. Also, the extraction unit 105A may generate a matter suggested in the content as a whole from the suggested matter extracted from the non-text element, which has been converted into text, and the suggested matter extracted from the text element. The LLM is caused to generate the suggested matter as a whole. Note that in a case where the text element and the non-text element, which has been converted into text, are integrated to generate one piece of text in S12, the extraction unit 105A can extract the matter suggested in the content as a whole from the one piece of text.

In S14, the verification information acquisition unit 106A acquires verification information serving as a basis of truth/falsity determination by the truth/falsity determination unit 101A. As described above, the verification information acquisition unit 106A may acquire external information detected by searching as the verification information, may acquire internal information input to the information processing apparatus 1A as the verification information, or may acquire both the external information and the internal information as the verification information. In a case where the verification information is acquired by searching, for example, the verification information acquisition unit 106A performs searching based on at least one of the text generated in S12, the text element included in the content acquired in S11, and the non-text element included in the content acquired in S11, and obtains the verification information.

In S15, the text conversion unit 104A converts the non-text element included in the verification information acquired in S14 into text. Note that in a case where one piece of verification information includes a text element and a non-text element, text indicating the matter suggested in the verification information as a whole may be generated from the non-text element, which has been converted into text, and the text element. This is similar to the case where a matter suggested in content as a target of truth/falsity determination is extracted. The processing in S15 is omitted in a case where any non-text element is not included in the verification information acquired in S14.

In S16, the truth/falsity determination unit 101 determines truth/falsity of the suggested matter extracted in S13 using the verification information acquired in S14 and the text generated in S15. Note that the text indicating the matter suggested in the verification information as a whole may be generated from the text element included in one piece of verification information and the text generated from the non-text element included in the verification information as described above. In this case, the truth/falsity determination is performed using the text indicating the matter suggested in the verification information as a whole. Also, in a case where a plurality of pieces of verification information are acquired in S14, the truth/falsity determination is performed using the plurality of pieces of verification information.

In S17, the redetermination necessity determination unit 107A determines whether to end the truth/falsity determination. Since the method of determining whether to end the truth/falsity determination is as described above, the description will not be repeated here. The processing proceeds to S18 in case where the determination result in S17 is YES, or the processing proceeds to S19 in a case where the determination result in S17 is NO.

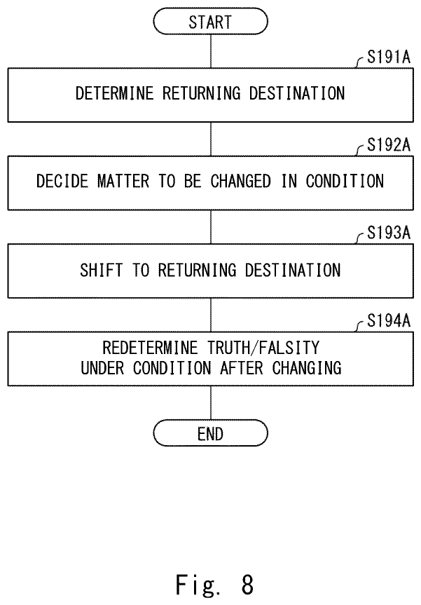

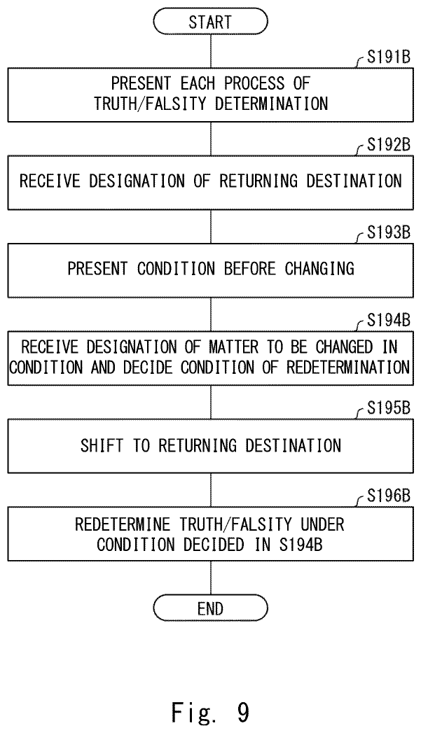

In S19, the returning destination deciding unit 108A decides a returning destination, the condition changing unit 102A changes the condition, and the truth/falsity determination unit 101A redetermines truth/falsity of the matter suggested in the content based on the condition after the changing. After the processing in S19 ends, the processing returns to S17. Note that details of S19 will be described later with reference to FIGS. 8 and 9.

In S18, the presentation control unit 110A presents the determination result to the user. For example, the presentation control unit 110A may cause the report creation unit 109A to generate a report including the result of determining truth/falsity of the suggested mater and basis information indicating the basis of the determination result and present the generated report as the determination result.

Note that in a case where a plurality of pieces of text representing the suggested matter are extracted in S13, the processing in S14 to S16 is repeatedly performed for each of the suggested matters. In this case, a report indicating a result of determining truth/falsity may be generated and presented for each suggested matter. Moreover, truth/falsity may be comprehensively determined from each determination result in this case.

### (Details of Redetermination Processing: Automatic Processing)

Details of the redetermination processing performed in S19 in FIG. 7 will be described based on FIG. 8. FIG. 8 is a flowchart illustrating an example of the redetermination processing.

In S191A, the returning destination deciding unit 108A decides from which of the series of processes to obtain a result of truth/falsity determination the processing is to be started again in the redetermination. For example, the returning destination deciding unit 108A may decide the returning destination by inputting, to the LLM, various kinds of information necessary to decide the returning destination, such as the details of the processing in each process in the previous determination, and causing the LLM to output an appropriate returning destination as described above. Furthermore, the returning destination deciding unit 108A may decide the returning destination by another method such as utilization of a rule base, for example.

In S192A, the condition changing unit 102A decides a matter to be changed in the condition in the returning destination decided in S191A. For example, the condition changing unit 102A may decide the matter to be changed by inputting, to the LLM, various kinds of information necessary to decide the matter to be changed in the condition of the truth/falsity determination, such as a condition that has been applied to the previous determination, and causing the LLM to output the appropriate matter to be changed as described above. Also, the condition changing unit 102A may decide the matter to be changed by another method such as utilization of a rule base, for example.

In S193A, the processing shifts to the returning destination decided in S191A. The returning destination is, for example, any of S12 to S16 in the flow in FIG. 7. Then, the condition after the changing in S192A is applied in S194A, the processing from the returning destination, to which the processing has been shifted in S193A, to S16 in FIG. 7 is performed, and the truth/falsity determination unit 101A redetermines truth/falsity of the suggested matter in S16.

Note that in S191A, a plurality of processes for which conditions are to be changed may be decided. In that case, a matter to be changed in the condition in each of the processes decided in S191A is decided in S192A. In S193 A, the processing returns to the process that is to be executed first from among the processes decided in S191A, and the processing for the redetermination is performed from the process.

As described above, the returning destination deciding unit 108A may input the series of processes to obtain the result of the truth/falsity determination to the language model after machine learning, cause the language model to generate an output indicating from which of the processes the processing is to be started again, and decide from which of the processes the processing is to be started again based on the output. Therefore, an effect that it is possible to automatically decide from which processes the redetermination processing is to be started again without intervention of the user is obtained in addition to the effect achieved by the information processing apparatus 1.

### (Details of Redetermination Processing: User Processing)

Another example of the redetermination processing in S19 in FIG. 7 will be described based on FIG. 9. FIG. 9 is a flowchart illustrating another example of the redetermination processing.

In S191B, the presentation control unit 110A presents each process of the truth/falsity determination as a candidate for the returning destination to the user. For example, the presentation control unit 110A may cause the report creation unit 109A to generate a report as illustrated in FIG. 5 including each process of the truth/falsity determination and present the report to the user. Note that it is not always necessary to present each process as a candidate for the returning destination in the form of the report. However, the presentation control unit 110A preferably presents each candidate together with information to be referred to when the user determines the returning destination (for example, information used and/or generated in each process in the previous truth/falsity determination).

In S192B, the returning destination deciding unit 108A receives designation of the returning destination. In a case where a report R1 illustrated in FIG. 5 is presented in S191B, for example, the returning destination deciding unit 108A receives an operation of selecting any of returning destination selection buttons R20 to R23 as having been performed to designate the returning destination corresponding to the returning destination selection button.

In S193B, the presentation control unit 110A presents the condition before the changing in the returning destination designated in S192B, that is, the condition applied in the previous truth/falsity determination to the user. In a case where the returning destination selection button R21 in the report R1 illustrated in FIG. 5 is selected, for example, the presentation control unit 110A may present a UI screen EX1 illustrated in FIG. 6. Similarly, in a case where a returning destination selection button R22 in the report R1 illustrated in FIG. 5 is selected, the presentation control unit 110A may present a UI screen EX2 illustrated in FIG. 6.

In S194B, the condition changing unit 102A receives the designation of the matter to be changed in the condition and decides a condition of the redetermination. For example, the condition changing unit 102A may receive designation of the matter to be changed in the condition via the UI screen EX1 or the UI screen EX2 illustrated in FIG. 6 from the user.

The processing in S195B and S196B is similar to that in S193A and S194A in FIG. 8. Note that a plurality of processes of changing the condition may be included as described above in FIG. 8. Furthermore, the returning destination may be automatically decided by the processing in S191A in FIG. 8, and the condition may be changed via the user by the processing in S193B and S194B in FIG. 9. Furthermore, the returning destination may be decided via the user by the processing in S191B and S192B in FIG. 9, and the condition may be automatically changed by the processing in S192A of FIG. 8.

As described above, the information processing apparatus 1A includes the presentation control unit 110A that presents the condition before the changing by the condition changing unit 102A to the user. In this case, the condition changing unit 102A may receive user's designation of the matter to be changed in the presented condition as a target and decide the condition of the redetermination by incorporating the designated matter to be changed. In this manner, an effect that it is possible to reflect a user's intention to the decision of the condition of the redetermination is obtained in addition to the effect achieved by the information processing apparatus 1.

As described above, the information processing apparatus 1A may include the presentation control unit 110A that presents the series of processes to obtain a result of truth/falsity determination along with information indicating details of processing in each process to the user, and the condition changing unit 102A may receive user's designation of a returning destination in the presented series of processes and decide the designated returning destination as the returning destination in the redetermination. In this manner, an effect that it is possible to reflect a user's intention to the decision of the returning destination is obtained in addition to the effect achieved by the information processing apparatus 1.

### MODIFIED EXAMPLES

Any entity may be an executing entity of the processing described in the aforementioned illustrative example embodiment, and the executing entity is not limited to that in the aforementioned example. For example, a plurality of apparatuses that can communicate with each other can construct a system having functions similar to those of the information processing apparatuses 1 and 1A. Furthermore, the execution subject of the processing illustrated in the flowcharts illustrated in FIGS. 7 to 9 may be one apparatus (which can also be referred to as a processor instead) or may be a plurality of apparatuses (which can also be referred to as processors instead in the same manner).

### [Example of Implementation by Software]

Some or all of the functions of the information processing apparatuses 1 and 1A may be implemented by hardware such as an integrated circuit (IC chip) or may be implemented by software.

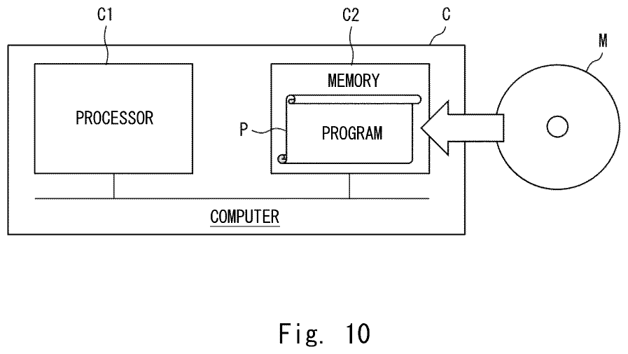

In the latter case, the information processing apparatuses 1 and 1A are implemented by a computer that executes commands of a program, which is software that implements each function, for example. An example of such a computer (hereinafter, referred to as a computer C) is illustrated in FIG. 10. FIG. 10 is a block diagram illustrating a hardware configuration of the computer C that functions as the information processing apparatuses 1 and 1A.

The computer C includes at least one processor C1 and at least one memory C2. A program P for causing the computer C to operate as the information processing apparatuses 1 and 1A is recorded in the memory C2. In the computer C, the processor C1 executes each function of the information processing apparatuses 1 and 1A by reading the program P from the memory C2 and executing the program P.

As the processor C1, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof, for example, can be used. As the memory C2, a flash memory, a hard disk drive (HDD), a solid state drive (SSD), or a combination thereof, for example, can be used.

Note that the computer C may further include a random access memory (RAM) for developing the program P at the time of execution and temporarily storing various kinds of data. In addition, the computer C may further include a communication interface for transmitting and receiving data to and from other apparatuses. The computer C may further include an input/output interface for connecting input/output devices such as a keyboard, a mouse, a display, and a printer.

In addition, the program P can be recorded in a non-transitory tangible recording medium M that is readable by the computer C. As such a recording medium M, a tape, a disk, a card, a semiconductor memory, a programmable logic circuit, or the like, for example, can be used. The computer C can acquire the program P via such a recording medium M. In addition, the program P can be transmitted via a transmission medium. As such a transmission medium, a communication network, a broadcast wave, or the like, for example, can be used. The computer C can also acquire the program P via such a transmission medium.

Furthermore, each of the above-described functions of the information processing apparatuses 1 and 1A may be implemented by a single processor provided in a single computer, may be implemented by cooperation of a plurality of processors provided in a single computer, or may be implemented by cooperation of a plurality of processors provided in a plurality of computers. Furthermore, the program for causing the information processing apparatuses 1 and 1A to implement the above-described functions may be stored in a single memory provided in a single computer, may be stored in a distributed manner in a plurality of memories provided in a single computer, or may be stored in a distributed manner in a plurality of memories provided in a plurality of computers.

### [Supplementary Notes]

The present disclosure includes the technologies described in the following supplementary notes. It should be noted that the present invention is not limited to the technologies described in the following supplementary notes, and various modifications can be made within the scope described in the claims.

### (Supplementary Note 1)

An information processing apparatus including truth/falsity determination means for determining truth/falsity of a matter suggested in content, and condition changing means for changing a condition of truth/falsity determination, in which the truth/falsity determination means redetermines truth/falsity of the matter suggested in the content under a condition after the changing by the condition changing means.

### (Supplementary Note 2)

The information processing apparatus according to Supplementary Note 1, in which the condition changing means decides a matter to be changed in the condition of the truth/falsity determination using a language model after machine learning.

### (Supplementary Note 3)

The information processing apparatus according to Supplementary Note 2, in which the condition changing means decides the matter to be changed in the condition of the truth/falsity determination using a language model to decide the matter to be changed in the condition of the truth/falsity determination, which is different from a language model after machine learning used in a series of processes to obtain a result of the truth/falsity determination.

### (Supplementary Note 4)

The information processing apparatus according to Supplementary Note 1, further including presentation control means for presenting a condition before the changing by the condition changing means to a user, in which the condition changing means receives a matter to be changed in the presented condition as a target designated by the user and decides a condition of redetermination by reflecting the designated matter to be changed.

### (Supplementary Note 5)

The information processing apparatus according to any one of Supplementary Notes 1 to 4, further including returning destination deciding means for deciding from which of a series of processes to obtain a result of the truth/falsity determination processing is to be started again for the redetermination.

### (Supplementary Note 6)

The information processing apparatus according to Supplementary Note 5, in which the returning destination deciding means inputs the series of processes to a language model after machine learning, causes the language model to generate an output indicating from which of the processes processing is to be started again, and decides from which of the processes the processing is to be started again based on the output.

### (Supplementary Note 7)

The information processing apparatus according to Supplementary Note 5, further including presentation control means for presenting the series of processes along with information indicating details of processing in each process to a user, in which the condition changing means receives a returning destination designated by the user from among the presented series of processes and decides the designated returning destination as a returning destination for the redetermination.

### (Supplementary Note 8)

The information processing apparatus according to any one of Supplementary Notes 1 to 7, further including redetermination necessity determination means for determining whether to perform redetermination by using a determination result of the truth/falsity determination means.

### (Supplementary Note 9)

The information processing apparatus according to any one of Supplementary Notes 1 to 3, in which the condition changing means receives an input of text indicating a matter to be changed in the condition and decides a condition of redetermination by reflecting the matter to be changed extracted from the text.

### (Supplementary Note 10)

The information processing apparatus according to any one of Supplementary Notes 1 to 3, in which the condition changing means changes a prompt to be input to a language model after learning that has been used in at least any of a series of processes to obtain a result of the truth/falsity determination.

### (Supplementary Note 11)

The information processing apparatus according to any one of Supplementary Notes 1 to 3, in which the condition changing means includes at least either a prompt input to a language model after learning in at least any of a series of processes to obtain a result of the truth/falsity determination or an output obtained by the prompt in input data of the language model in redetermination.

### (Supplementary Note 12)

A determination method including executing, at least by one processor, truth/falsity determination processing of determining truth/falsity of a matter suggested in content, condition changing processing of changing a condition of truth/falsity determination, and processing of redetermining truth/falsity of the matter suggested in the content under the condition after the changing.

### (Supplementary Note 13)

A determination program that causes a computer to function as truth/falsity determination means for determining truth/falsity of a matter suggested in content and condition changing means for changing a condition of truth/falsity determination, in which the truth/falsity determination means redetermines truth/falsity of the matter suggested in the content under the condition after the changing by the condition changing means.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

1. An information processing apparatus comprising:
at least one memory storing computer-executable instructions; and
at least one processor configured to access the at least one memory and execute the computer-executable instructions to:
(a) determine a truth or falsity of a matter suggested in content based on a first condition;
(b) change the first condition to a second condition; and
(c) redetermine the truth or falsity of the matter suggested in the content based on the second condition.

2. The information processing apparatus according to claim 1, wherein
the at least one processor is further configured to execute the instructions to use a pre-trained language model to decide a matter to be changed in the condition of the truth/falsity determination.

3. The information processing apparatus according to claim 2, wherein
the pre-trained language model used to decide the matter to be changed is different from a language model trained through machine learning used in a series of processes to obtain a result of the truth/falsity determination.

4. The information processing apparatus according to claim 1, wherein
the at least one processor is further configured to:
(a) present, to a user, the condition before being changed;
(b) receive, from the user, a designation of a matter to be changed in the presented condition; and
(c) determine a condition for redetermination by reflecting the designated matter to be changed.

5. The information processing apparatus according to claim 1, wherein
the at least one processor is further configured to determine, in the redetermination, from which process in a series of processes for obtaining the result of the truth/falsity determination the processing is to be restarted.

6. The information processing apparatus according to claim 5, wherein
the at least one processor is configured to:
(a) input the series of processes into a language model trained through machine learning;
(b) cause the language model to generate an output indicating from which process the redetermination is to be started; and
(c) determine the restarting process based on the generated output.

7. The information processing apparatus according to claim 5, wherein
the at least one processor is further configured to:
(a) present, to a user, the series of processes together with information indicating details of processing in each process;
(b) receive, from the user, a designation of a restarting process from among the presented series of processes; and
(c) determine the designated process as the restarting point for the redetermination.

8. The information processing apparatus according to claim 1, wherein
the at least one processor is further configured to determine whether redetermination is to be performed, based on the result of the truth/falsity determination.

9. The information processing apparatus according to claim 1, wherein
the at least one processor is configured to:
(a) receive input of text indicating a matter to be changed in the condition;
(b) extract the matter to be changed from the text; and
(c) determine a condition for redetermination by reflecting the extracted matter.

10. The information processing apparatus according to claim 1, wherein
the at least one processor is configured to change a prompt input to a language model trained through machine learning, the language model being used in at least one of the series of processes for obtaining the result of the truth/falsity determination.

11. The information processing apparatus according to claim 1, wherein
the at least one processor is configured to include, in input data for the language model in the redetermination, at least one of:
(a) a prompt that was input to the language model in at least one of the series of processes for obtaining the result of the truth/falsity determination; and
(b) an output obtained from the prompt.

12. A method of determining a truth or falsity of a matter suggested in content, the method being performed by a computer executing instructions stored in a memory, the method comprising:
(a) determining the truth or falsity of a matter suggested in content based on a first condition;
(b) changing the first condition to a second condition; and
(c) redetermining the truth or falsity of the matter suggested in the content based on the second condition.

13. A non-transitory computer-readable storage medium that stores a computer-executable program for determining a truth or falsity of a matter suggested in content, the program comprising instructions for:
(a) determining the truth or falsity of a matter suggested in content based on a first condition;
(b) changing the first condition to a second condition; and
(c) redetermining the truth or falsity of the matter suggested in the content based on the second condition.
